(19) United States
(12) Patent Application Publication
(10) Pub. No.: US 2019/0319480 A1
(43) Pub. Date: Oct. 17, 2019

(54) EMERGENCY DRIVER SYSTEM FOR PROVIDING A LOW FLOAT CHARGE POWER TO A RECHARGEABLE BATTERY

(71) Applicant: Fulham Company Limited, George Town (KY)

(72) Inventors: Qixiang CUI, Shanghai (CN); Chunyan Han, Beijing (CN)

(21) Appl. No.: 15/959,060

(22) Filed: Apr. 20, 2018

(30) Foreign Application Priority Data
Apr. 13, 2018 (CN) 201820522465.7

(51) Int. Cl. H02J 9/04; H01M 10/44; H02J 7/00; H05B 33/08; H05B 37/02

(52) U.S. Cl. CPC H02J 9/04; H01M 10/44; H02J 2007/0095; H05B 33/0842; H05B 37/0209; H02J 7/0083

(57) ABSTRACT

An emergency driver system is disclosed for providing a low float charge power to a rechargeable battery. For one example, an emergency light emitting diode (LED) driver system includes a LED light source, a rechargeable battery, and emergency (EM) driver. The emergency LED driver system can also include a multi-color indicator circuit configured to a provide at least two LED light indicators providing information regarding the mode of operation for the EM driver. The rechargeable battery is coupled with the LED light source. The EM driver is coupled with the rechargeable battery and the LED light source. In one example, the EM driver includes a charge circuit configured to supply a charge current to the rechargeable battery, and a micro-controller unit configured to control the charge current from the charge circuit such that a power loss in at least standby mode is less than 0.5 watts (W). The rechargeable battery can be a LiFePO₄ rechargeable battery providing an emergency illumination light source. By providing standby power of less than 0.5W for a LiFePO₄ rechargeable battery, the EM driver with a flyback circuit followed by a buck circuit can save energy when the rechargeable battery is fully charged.

### FIELD

Examples and embodiments of the invention are in the field of power systems and batteries. More particularly, examples and embodiments of the invention are directed an emergency driver system for providing a low float charge power to a rechargeable battery.

### BACKGROUND

Rechargeable batteries are a common type of power source. One type of rechargeable battery is a lithium ferro phosphate battery (LFP) such as a LiFePO₄ battery. These types of batteries use a lithium iron phosphate as a cathode and a graphitic carbon electrode with a metallic current collector grid as an anode. During charging, charged particles accumulate on the anode from the cathode, and for discharging the charged particles move back to the cathode form the anode. LiFePO₄ batteries can have any number of applications. For example, one application for LiFePO₄ rechargeable battery can be a power source for an emergency illumination or lighting source such as an emergency light emitting diode (LED) driver or an EM driver. These types of emergency EM drivers for an LED light source require efficient use of the LiFePO₄ rechargeable battery in providing emergency power to an illuminating light source LED so as not to waste energy during battery charging or discharging including battery standby and off modes.

### SUMMARY

An emergency driver system is disclosed for providing a low float charge power to a rechargeable battery. For one example, an emergency light emitting diode (LED) driver system includes a LED light source, a rechargeable battery, and emergency (EM) driver. The emergency LED driver system can also include a multi-color indicator circuit configured to a provide at least two LED light indicators providing information regarding the mode of operation for the EM driver. The rechargeable battery is coupled with the LED light source. The EM driver is coupled with the rechargeable battery and the LED light source. In one example, the EM driver includes a charge circuit configured to supply a charge current to the rechargeable battery, and a micro-controller unit configured to control the charge current from the charge circuit such that a power loss in at least standby mode is less than 0.5 watts (W). The rechargeable battery can be a LiFePO₄ rechargeable battery providing an emergency illumination light source.

For one example, the charge circuit includes a flyback circuit followed by a buck circuit. The flyback circuit and the buck circuit can each be configured to supply the charge current to the rechargeable battery. The micro-controller unit is further configured to control the charge current to be maintained at a charge rate (C-rate) of at least 0.005 C for providing at least 9.6 volts (V) and 3000 mili-amps (mA) to the rechargeable battery. By providing standby power of less than 0.5 W for a LiFePO₄ rechargeable battery, the EM driver with a flyback circuit followed by a buck circuit can save energy when the rechargeable battery is fully charged. The micro-controller unit is also configured to provide a minimum switching frequency of 600 Hz to 1 kHZ, and the minimum switching frequency can be user configurable in order to maintain a standby power consumption of less than 200 mW. The micro-controller unit is also configured to provide a charge current of 15 mA to the rechargeable battery and maintain the rechargeable battery when fully charged to about 10.65 V.

### BRIEF DESCRIPTION OF THE DRAWINGS

The present invention will be understood more fully from the detailed description given below and from the accompanying drawings of various examples and examples which, however, should not be taken to the limit the invention to the specific examples and examples, but are for explanation and understanding only.

FIG. 1 is one example block diagram of an emergency LED driver (EM) system having a charge circuit including a flyback circuit and buck circuit for a rechargeable battery.

FIG. 2 is one example of the charge circuit for the EM driver of FIG. 1.

FIG. 3 is one example of a micro-controller unit for the EM driver of FIG. 1.

FIG. 4 is one example of the multi-color indicator circuit of FIG. 1.

FIG. 5 is one example of a flow diagram illustrating a main function operation for the EM system of FIGS. 1-4.

FIG. 6 is one example of a flow diagram illustrating an operation for the EM system of FIGS. 1-5 to charge a rechargeable battery.

FIG. 7A is another example of a flow diagram illustrating an operation for the EM system of FIGS. 1-4 to charge a rechargeable battery

FIG. 7B is one example of a continuation of the flow diagram and operation of FIG. 7A.

FIG. 7C is one example of a continuation of the flow diagram and operation of FIGS. 7A-7B.

### DETAILED DESCRIPTION

An emergency driver system is disclosed for providing a low float charge power to a rechargeable battery. For one example, an emergency light emitting diode (LED) driver system includes a LED light source, a rechargeable battery, and emergency (EM) driver. The emergency LED driver system can also include a multi-color indicator circuit configured to a provide at least two LED light indicators providing information regarding the mode of operation for the EM driver. The rechargeable battery is coupled with the LED light source. The EM driver is coupled with the rechargeable battery and the LED light source. In one example, the EM driver includes a charge circuit configured to supply a charge current to the rechargeable battery, and a micro-controller unit configured to control the charge current from the charge circuit such that a power loss in at least standby mode is less than 0.5 watts (W). The rechargeable battery can be a LiFePO₄ rechargeable battery providing an emergency illumination light source. The charge circuit can include a flyback circuit followed by a buck circuit. The flyback circuit and the buck circuit can be configured to supply the charge current to the rechargeable battery. By providing standby power of less than 0.5 W for a LiFePO₄ rechargeable battery, the EM driver with a flyback circuit followed by a buck circuit can save energy when the rechargeable battery is fully charged.

For one example, the micro-controller unit controls the charge current to be maintained at a charge rate (C-rate) of at least 0.005 C for providing at least 9.6 volts (V) and 3000 mili-amps (mA) to the rechargeable battery. For one example, the micro-controller unit can provide a minimum switching frequency of 600 Hz to 1 kHZ, and the minimum switching frequency can be user configurable in order to maintain a standby power consumption of less than 200 mW. For one example, the micro-controller can provide a charge current of 15 mA to the rechargeable battery and maintain the rechargeable battery when fully charged to about 10.65 V.

As set forth herein, various embodiments, examples and aspects will be described with reference to details discussed below, and the accompanying drawings will illustrate various embodiments and examples. The following description and drawings are illustrative and are not to be construed as limiting. Numerous specific details are described to provide a thorough understanding of various embodiments and examples. However, in certain instances, well-known or conventional details are not described in order to provide a concise discussion of the embodiments and examples. Although the following examples and embodiments are directed to an emergency driver for an LED light source, the emergency driver and power features disclosed herein can apply and directed to any type of device receiving power from a rechargeable power source.

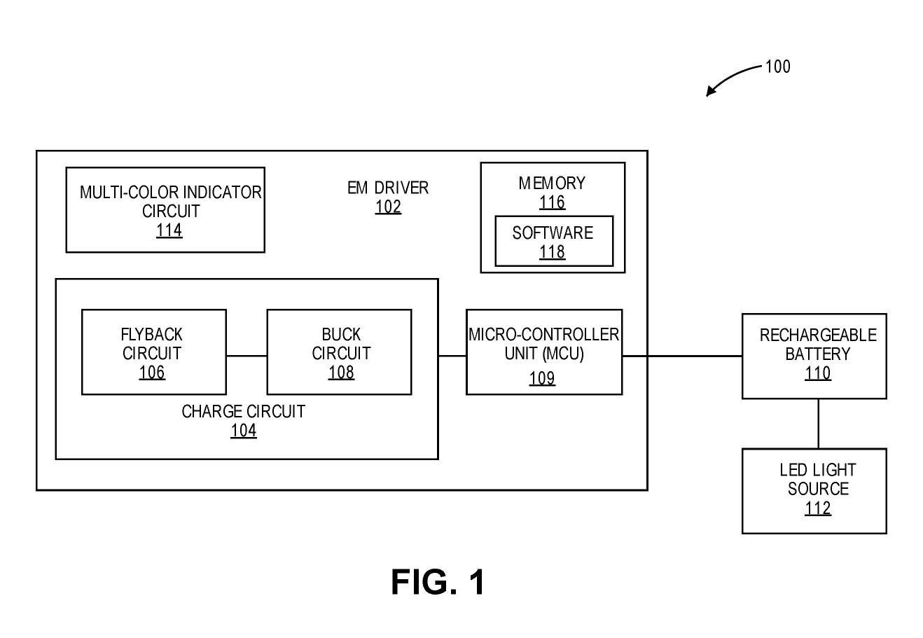

FIG. 1 is one example block diagram of an emergency LED driver (EM) system 100 having an EM driver 102 with a charge circuit 104 including a flyback circuit 106 and buck circuit 108 for a rechargeable battery 110. Coupled to charge circuit 104 is a micro-controller unit (MCU) 109 configured to control power from charge circuit 104 to rechargeable battery 110 that provides a power supply to LED light source 112. For one example, micro-controller unit 109 can be coupled to memory 116 including software 118 or any other components to receive inputs or instructions to program micro-controller unit 109. EM driver 102 also includes a multi-color indicator circuit 114 providing status information to a user of EM system 100. In one example, charge circuit 104 can provide constant current (CC) or constant voltage (CV) to charge rechargeable battery 110. In this example, charge circuit 104 can provide a charge scheme of a flyback circuit 106 followed by a buck circuit 108 to provide a CC or CV. For one example, charge circuit 104 having a flyback circuit 106 followed by buck circuit 108 can provide power or a power voltage micro-controller circuit 109. In one example, micro-controller unit 109 can be a pulse width modulation (PWM) controller to control power from charge circuit 104 to rechargeable battery 110. In one example, rechargeable battery is lithium ferro phosphate battery (LFP) such as a LiFePO₄ battery providing a power source for LED light source 112.

For the example of FIG. 1, micro-controller unit 109 can control power from charge circuit 104 to rechargeable battery 110 in at least standby mode of less 0.5 watts (W) for EM driver 102. For example, micro-controller unit 109 can control a low float charge power to rechargeable battery 110 of less than 0.5 W. In this way, charge circuit 104 can save energy when rechargeable battery 110, e.g., a LiFePO₄ rechargeable battery, is fully charged for EM driver 102 and in at least a standby mode. In one example, LED light source 112 can include one or more LEDs and provide an emergency illumination or lighting source. EM driver 102 by way of multi-color indicator circuit 114 can provide multi-color indicators indicating status and information regarding the different modes of operations for EM driver 102 to a user as disclosed herein.

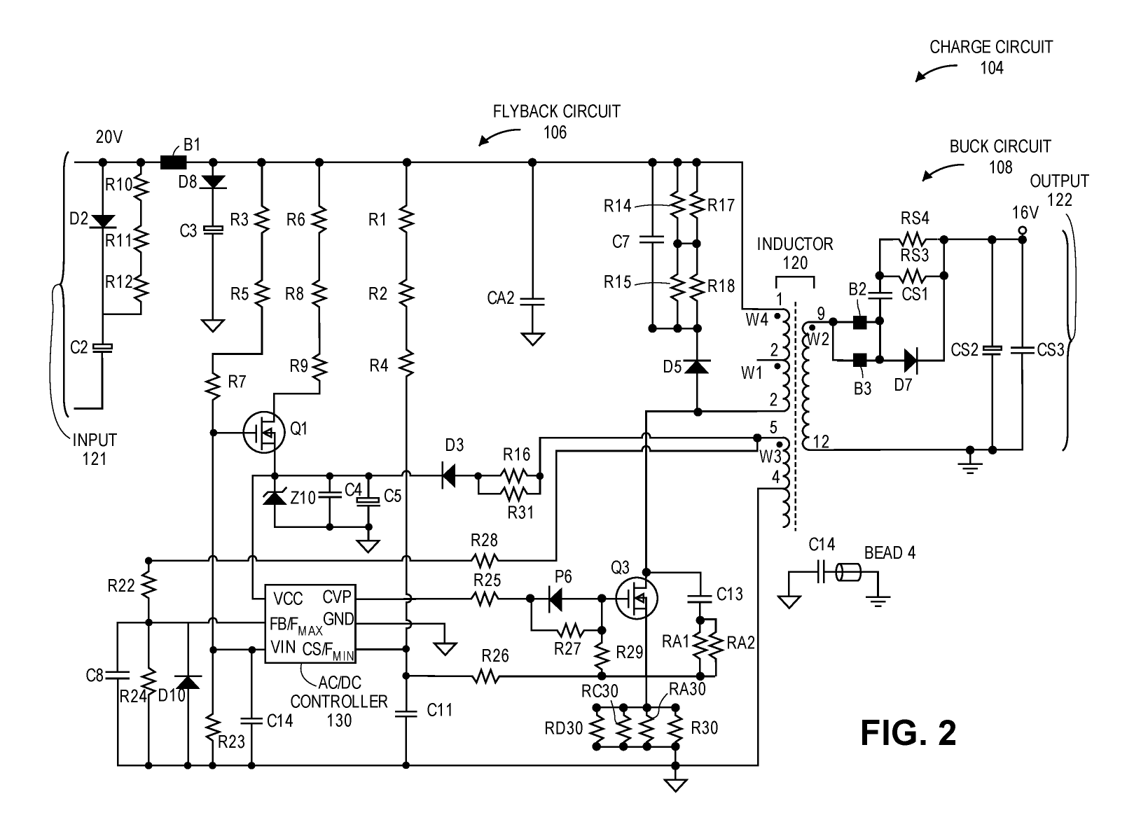

FIG. 2 is one example of a charge circuit 104 having a flyback circuit 106 followed by a buck circuit 108 for EM driver 102 of FIG. 1. Charge circuit 104 can be configured for alternating current (AC)/direct current (DC) or DC/DC conversion with an insolation between input 121 receiving AC input (e.g., 20V) and output 122 providing a DC output (e.g., 16V) by way of inductor 120 which can form a transformer. For example, charge circuit 104 can include flyback circuit 106 which is circuitry left of inductor 120 followed by buck circuit 108 which is circuitry right of inductor 120 shown in FIG. 2 Buck circuit 108 can operate as a buck converter or a step-down converter, which is a DC-to-DC (DC-DC) power converter. For one example, inductor 120 is split to form a transformer such that voltage ratios are multiplied with an additional advantage of isolation having an AC/DC controller 130.

For one example, in providing such a conversion, flyback circuit 106 and buck circuit 108 for charge circuit can have circuitry as shown in FIG. 2 including resistors (R1-R30, RA30, RD30, RC30, RA1-RA2, RS3-RS4), capacitors (C1-C14, CS1-CS3, CV4), transistors (Q1, Q3), diodes (D2-D10, Z10), inductor 120, beads (B1-B4), and AC/DC controller 130 having pins for V_{IN}, FB/F_{MAX}, VCC, CVP, GND, and CS/F_{MIN}. Inductor 120 can be coupled with noise suppression beads (B4) and beads (B1-B3) which can provide noise suppression for other electrical components for flyback circuit 106. AC/DC controller 130 can be configured to control output 122 of charge circuit 104 to provide a DC output voltage of 16V which is supplied to micro-controller unit 109. AC/DC controller 130 of flyback circuit 106 part of charge circuit 104 can be any type of high-performance single-stage AC/DC constant voltage (CV) controller with high power factor correction. For example, AC/DC controller 130 can be an iW3627 Off-Line Digital Constant-Voltage LED Driver with Power Factor Correction from iSemiconductor which can support the topology of flyback circuit 106 for charge circuit 104.

Regarding the pins for AC/DC controller 130, the V_{IN} pin is a multi-function pin to control active start-up and sense line voltage. The FB/F_{MAX} pin is a multi-function pin to configure maximum switching frequency (FMAX). This pin can also enable or disable an over-load protection (OLP) at start-up and can also provide output voltage sense for primary regulation during normal operation. The VCC pin can provide power supply to control logic and drive transistors within controller 130. The CVP pin or output can be used as the gate driver for external MOSFET transistor or switch such as Q3. The CS/F_{MIN} pin can be a multi-function pin used to configure minimum switching frequency (F_{MIN}) and at start-up. This pin can also provide primary current sense for cycle-by-cycle peak current control and limit during normal operation. In one example, the CS/F_{MIN} pin is user configurable that control a minimum switching frequency to be between 600 Hz and 1 kHz in order to provide light standby power consumption of less than <200 mW.

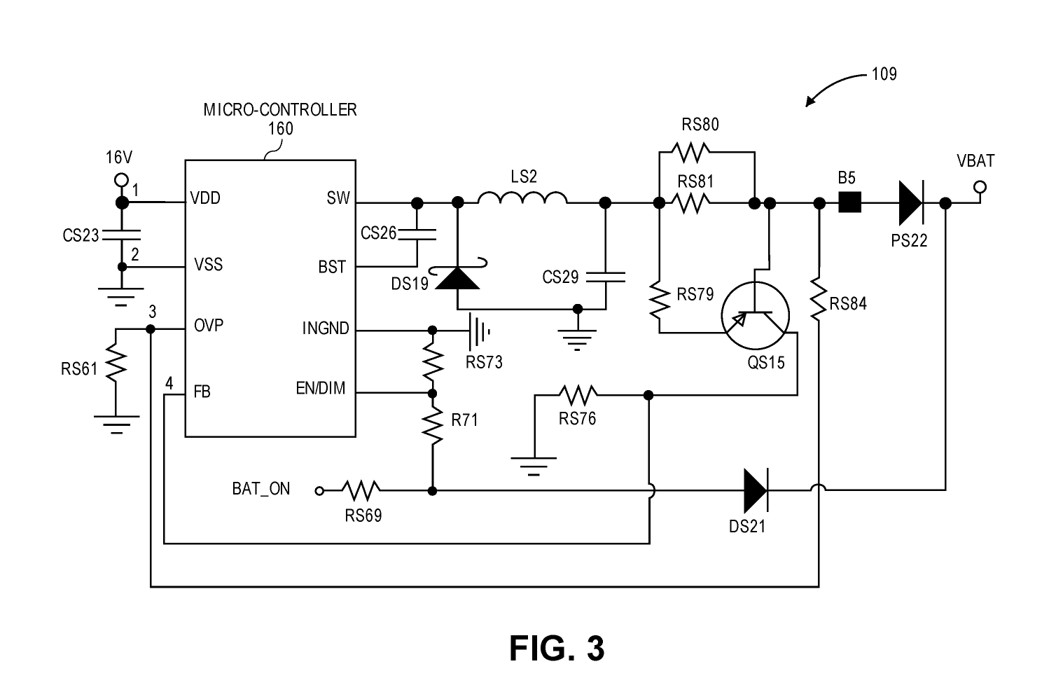

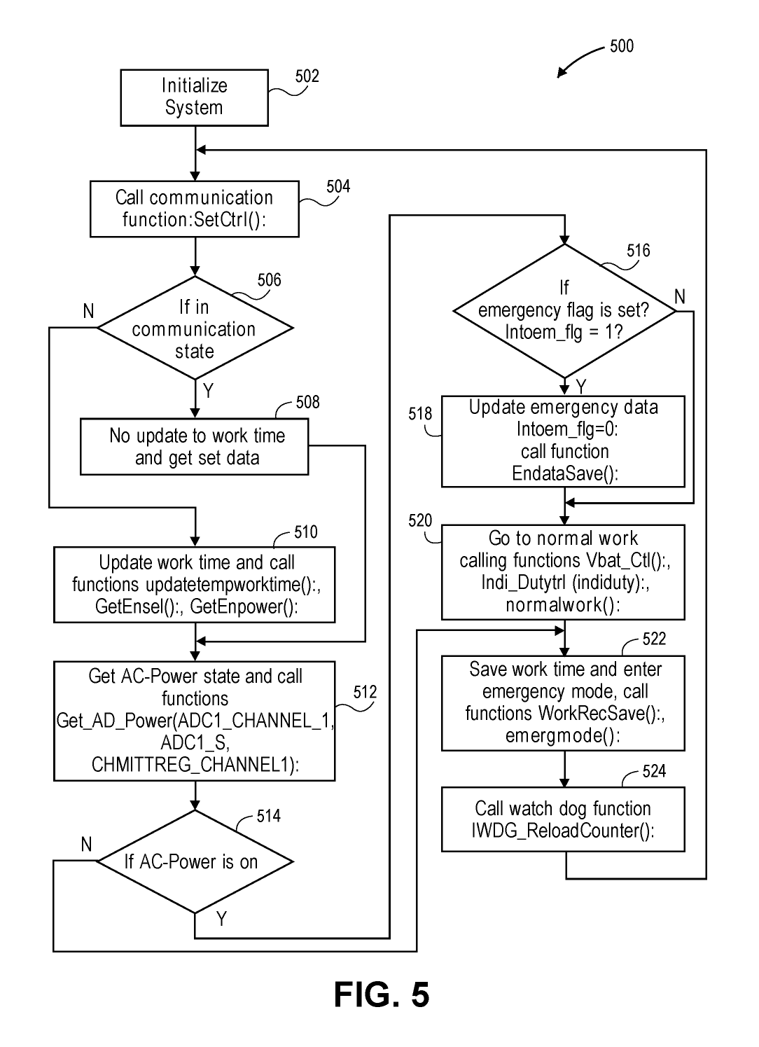

FIG. 3 is one example of micro-controller unit (MCU) 109 for EM driver 102 of FIG. 1. For one example, micro-controller unit 109 can be programmable and configured with a micro-controller 160, which can be any type of LED driver controller (or micro-controller) providing step-down, inverting step-up/down and step-up applications such as, e.g., as MP24833 LED controller from MPS. For one example, micro-controller unit 109 can be coupled to components such as memory 116 including software 118 to receive inputs or instructions in performing the operations described in FIGS. 5-7C. For one example, micro-controller 160 of micro-controller unit (MCU) 109 can control the charge current for rechargeable battery 110, which can be a LiFePO₄ rechargeable battery, using pulse width modulation (PWM). For one example, if the PWM is high, micro-controller 160 can control the charge current such that it will be a constant current for rechargeable battery 110. In one example, micro-controller 160 includes pins for VDD, VSS, OVP, FB, SW, BST, IN/GRND, and EN/DIM connected to capacitors (CS23, CS26, CS29), resistors (RS61, RS71, RS73, RS76, RS79, RS84), diodes (DS19, DS21, DS22), transistor (QS15), and bead B5 as shown in FIG. 3.

For example, micro-controller 160 can have a VDD input pin to receive a voltage of 16V from flyback circuit 106 at node 1, a VSS pin to receive a DC voltage from capacitor CS23 at node 2, a OVP (over-voltage protection) pin to determine a voltage at node 3 and if exceeds a threshold to shut off power to rechargeable battery 110 or cutoff switch (transistor) QS15, and a FB pin to receive and sense an LED feedback current related to sensing resistor RS76. Micro-controller 160 can also have a SW pin for switch output connected to power inductor LS2, a bootstrap BST pin that produce a floating supply for the power switch QS15 by way of capacitor CS26, input ground reference INGND pin providing a reference for the on/off control input and dimming control EN/DIM signal, and an EN/DIM pin to receive the on/off control input and dimming control signal which can implement DC and pulse width modulation dimming.

Micro-controller 160 can provide a PWM charge current for rechargeable battery 110 at approximately 15 mA, which can maintain rechargeable battery 110 at fully charged around 10.65V. For one example, when the voltage on rechargeable battery 110 is above 10.65V, micro-controller 160 can stop charge circuit 104 from providing power from charge circuit 104to rechargeable battery 110 by disabling the BAT_ON pin. For one example, if the voltage on rechargeable battery 110 is below 10.3V micro-controller 160 can provide a PWM pulse charge such voltage on rechargeable battery 110 is above 10.3V to ensure adequate power to rechargeable battery 110 with minimum power loss in standby mode or operation. In one example, micro-controller 160 of FIG. 3, it can also be configured or programmed to determine if rechargeable battery 110 is plugged in or not based on voltage changes or deltas, e.g., voltage changes or deltas across capacitor CS29. Such a determination can be performed within a certain period of time to obtain the correct voltage change or delta and provide useful information to the user without unnecessary delay.

For the examples of FIGS. 1-3, for EM driver 102 with charge circuit 104, including flyback circuit 106 and buck circuit 108, and micro-controller unit 109 as configured with micro-controller 160, a total standby power loss for keeping charge current at a charge rate (C-rate) of 0.005 C for providing at least 9.6V and 3000 mA to rechargeable battery 110, e.g., a LiFePO₄ rechargeable battery, can be less than 0.5 W (or 500 mW) at input of 120V. Such a power loss can meet battery standards and requirements such as from the California Emission Commission (CEC) and European Commission (CE), among others. For example, by using flyback circuit 106 followed by buck circuit 108 of FIG. 2, EM driver 102 can save energy by using a user-configurable minimum switching frequency between 600 Hz and 1 kHz, which ensures light-load standby power consumption of <200 mW. As such, EM driver 102 can provide features such that a standby power loss of the two stage charge circuit 104 (flyback circuit 106 and buck circuit 108) can be below 0.5 W.

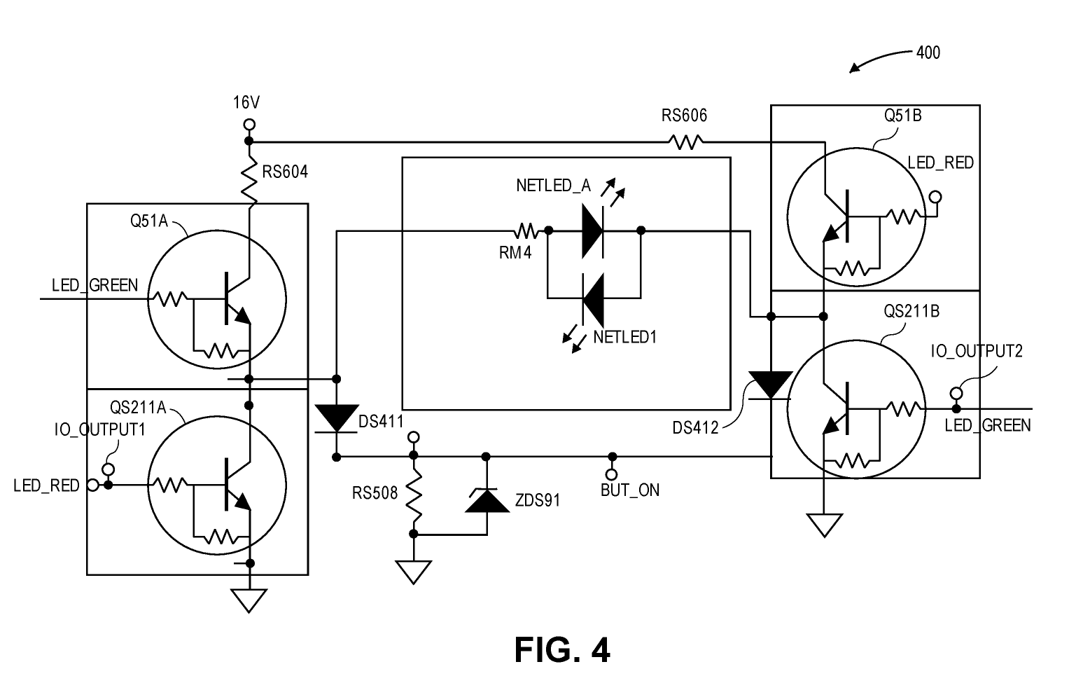

FIG. 4 is one example of multi-color indicator circuit 114 for EM driver 102 of FIG. 1. For one example, multi-color indicator circuit 114 includes a low voltage full bridge to control the direction of a green and red LEDs (e.g., LED_GREEN and LED_RED inputs). In one example, multi-color indicator circuit 114 can be configured with transistors or switches (QS1A, QS211A, Q51B, QS211B) which control LED_GREEN and LED_RED, respectively, resistors (RS604, RS508, RS606), and diodes (DS411, ZDS91, DS412, NetLED_1, NetLED1). Multi-color indicator circuit 114 also includes pins or connections for IO_output1, IO_output2, and BUT_ON.

For one example, the two color LEDs (GREEN and RED) show different status for EM driver 102. For example, when inputs on LED GREEN is high and LED RED is low to respective transistors or switches (QS1A, QS211A, Q51B, QS211B), a green LED indicator (upside) can turn on indicating a fully charged battery, otherwise, a RED light can turn on indicating the battery is not fully charged. In another example, multi-color indicator circuit 114 can receive on its BUT_ON pin detected voltage on rechargeable battery 110 which can inform micro-controller unit 109 to cutoff power to rechargeable battery 110 or when the total power loss of the circuit is not above 70 mW which can be indicated by a RED LED. It should be noted that more than one GREEN and RED LEDs can be provided to indicate the various modes of operation for EM driver 102 regarding rechargeable battery 110.

FIGS. 5-7C provide exemplary flow diagrams for operations of EM system 100 of FIGS. 1-4. Referring to FIG. 5, one example of a flow diagram of a main function operation 500 is illustrated for EM system 100 of FIG. 1. At block 502, EM system 100 is initialized. At block 504, a call is made to a communication function, e.g., SetCtrl( ):, which can set parameters for EM driver 102 including charge circuit 104 and micro-controller unit 109. At block 506, a decision is made if EM driver 102 is in a communication state (Y/N). At block 508, if EM driver 102 is determined to be in a communication state (Y), work time is not updated and get set data is performed and operation 500 proceeds to block 512. At block 510, if EM driver 102 is not in a communication state (N), work time is updated and function calls are made to updatetempworktime( ):, GetEnsel( ):, and GetEmpower( ): and operation 500 proceeds to block 512. At block 512, get the AC-Power state is performed and a function call is made to Get_AD_Power(ADC1_CHANNEL_1, ADC1_S, CHMITTRIG_CHANNEL1).

At block 514, a decision is made if AC-power is on (Y/N). If AC-power is on (Y), operation 500 proceeds to block 516. If AC-power is not on (N), operation 500 proceeds to block 522. At block 516, a decision is made if emergency flag is set—i.e., Intoem_flg=1? (Y/N). If the emergency flag is set to 1 (Y) and Intoem_flg=1, operation 500 proceeds to block 518 and if emergency flag is not set to 1 (N) and Intoem flg is not set to 1, operation 500 proceeds to block 520. At block 518, update emergency data is performed Intoem_flg is set to zero—i.e., Intoem_flg=0 and a function call is made to EndataSave( ):. At block 520, go to normal work is performed and function calls are made to Vbat_Ctl( ):, Indi_Dutytrl(indiduty):, and normalwork( ):. At block 522, save work time is performed and emergency mode is entered and function calls are made to WorkRecSave( ): and emergmode( ):. At block 524, watchdog function IWDG_ReloadCounter( ): is called.

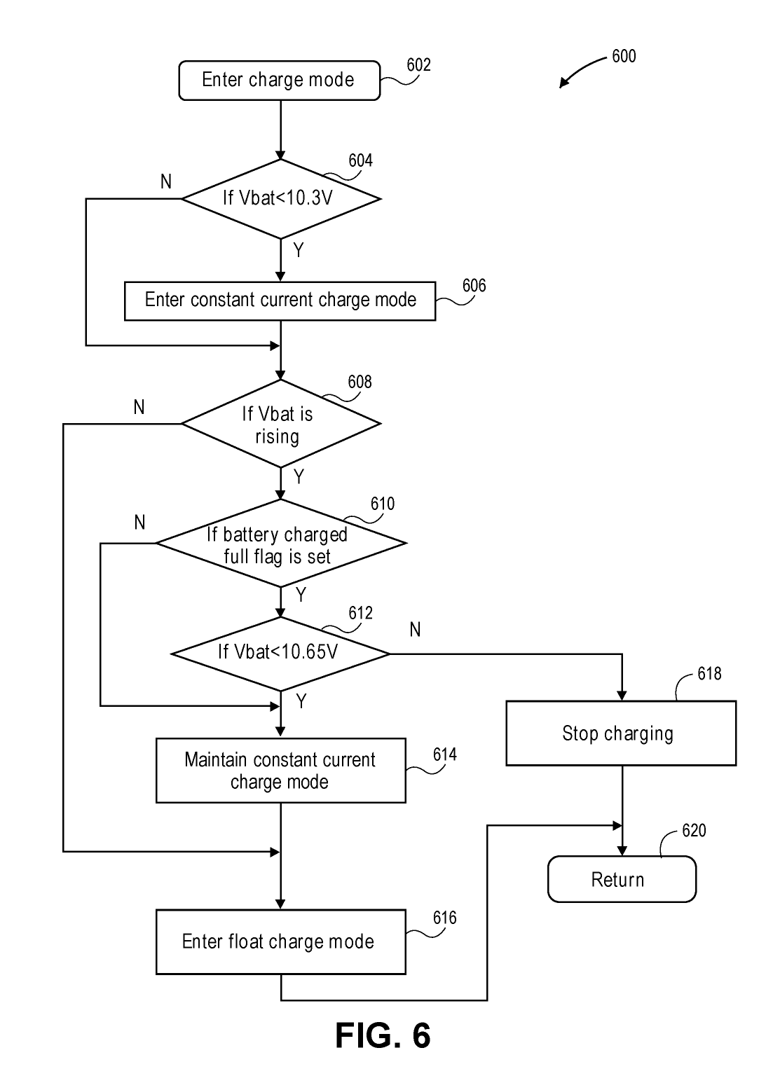

FIG. 6 is one example of a flow diagram illustrating an operation 600 for EM system 100 of FIGS. 1-4 to charge rechargeable battery 110. At block 602, a charge mode is entered for rechargeable battery 110. At block 604, a decision is made if the voltage VBat<10.3V (Y/N) for rechargeable battery 110. If Y, operation 600 proceeds to block 606 and, if N, operation 600 proceeds to block 608. At block 606, constant current charge mode is entered for rechargeable battery 110. For example, charge circuit 104 can be used to charge rechargeable battery 110. At block 608, a decision is made if the voltage VBat is rising for rechargeable battery 110 (Y/N). If Y, operation 600 proceeds to block 610, and, if no, operation 600 proceeds to block 616. At block 610, a decision is made if battery charged full flag is set (Y/N). If Y, operation 600 proceeds to block 612 and, if N, the operation proceeds to block 614. At block 612, a decision is made if the voltage Vbat<10.65V for rechargeable battery 110 (Y/N). If Y, operation 600 proceeds to block 614, and, if N, operation 600 proceeds to block 618. At block 614, constant current charge mode is maintained. At block 616, float charge mode is entered and the operation proceeds to block 620 that can return to a previous block such as decision block 604. At block 618, charging rechargeable battery 110 is stopped and operation 600 proceeds to block 620 that can return to a previous block such as block 602.

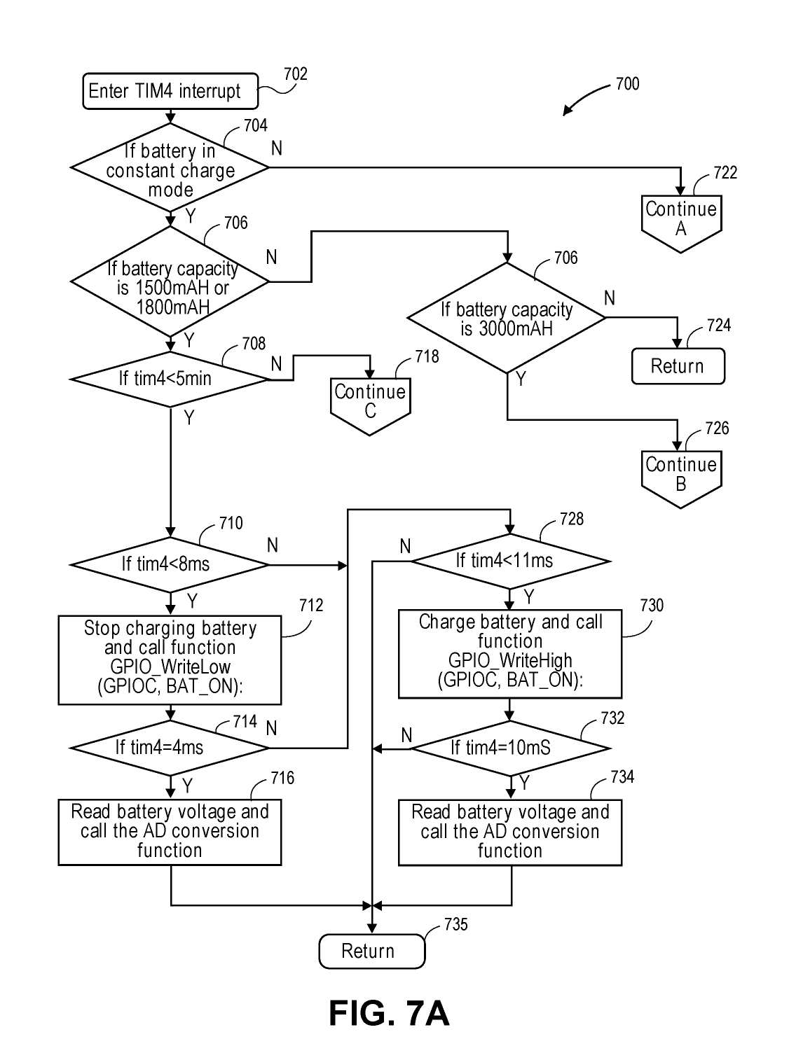

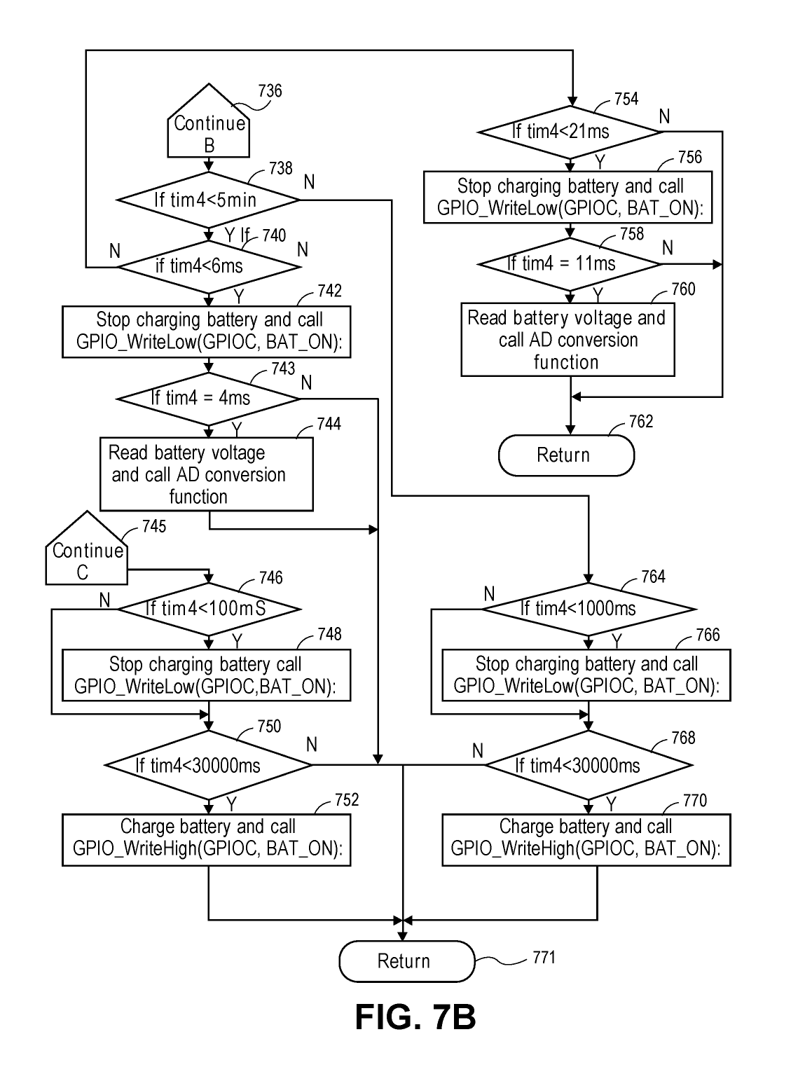

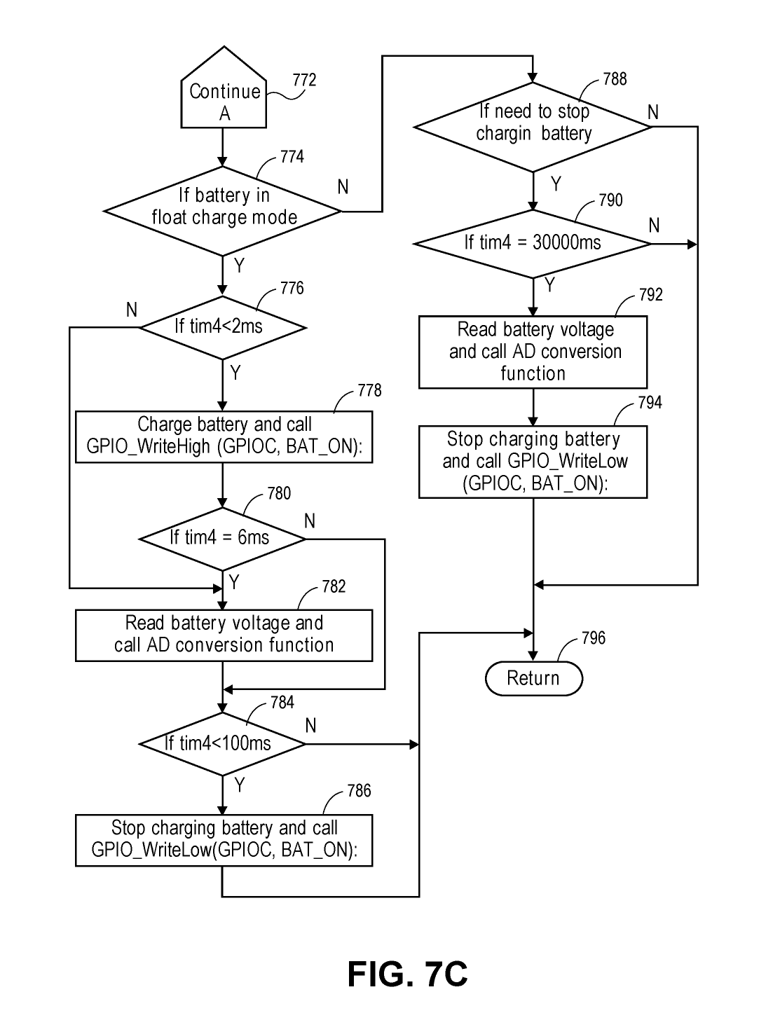

FIG. 7A is another example of a flow diagram illustrating an operation 700 for EM system 100 of FIGS. 1-4 to charge rechargeable battery 110. At block 702, a TIM4 interrupt operation is entered. At block 704, a decision is made if the battery, e.g., rechargeable battery 110, is in constant charge mode (Y/N). If Y, operation 700 proceeds to block 706, and if N, operation 700 continues (A) to block 722. At block 706, a decision is made if battery capacity is 1500 mAH or 1800 mAH (Y/N). If Y, operation 700 proceeds to block 708, and, if N, operation 700 proceeds to block 706. At block 706, a decision is made if the battery capacity is 3000 mAH (Y/N). If Y, operation 700 continues (B) to block 726, and, if N, operation 700 continues to block 724 and can return to a previous operation such as block 704 or block 702. At block 708, a decision is made if tim4 value of the interrupt is less <5 mins. If Y, operation 700 proceeds to block 710, and, if N, operation 700 continues (C) to block 718.

At block 710, a decision is made if tim4 value of the interrupt is less <8 mS. If Y, operation 700 proceeds to block 712, and, if N, operation 700 proceeds to block 728. At block 712, stop charging battery (e.g., rechargeable battery 110) and a function call is made to GPIO_WriteLow (GPIOC, BAT_ON):. At block 714, a decision is made if the tim4 value of the interrupt equals=4 ms (Y/N). If Y, operation 700 proceeds to block 716, and, if N, operation 700 proceeds to block 728. At block 716, the battery voltage is read and an analog-to-digital (AD) conversion function is called and operation 700 proceeds to block 735 where the operation can return to a previous operation such as block 704 or block 702. At block 728, a decision is made if the tim4 value of the interrupt is less <11 ms (Y/N). If Y, operation 700 proceeds to block 730, and, if N, operation 700 proceeds to block 735 and can return to a previous operation such as block 704 or block 702. At block 730, the battery is charged (e.g., rechargeable battery 110) and a function call is made to GPIO_WriteHigh(GPIOC, BAT_ON). At block 732, a decision is made if the tim4 value of the interrupt is equal=10 ms (Y/N). If Y, operation 700 proceeds to block 734, and, if N, operation 700 proceeds to block 735 and can return to a previous operation. At block 734, the battery voltage is read and the analog-to-digital (AD) conversion function is called and the operation returns to a previous operation such as block 704 or block 702.

FIG. 7B is one example of a continuation of the flow diagram and operation 700 of FIG. 7A. At block 736, operation 700 continues for (B), and at block 745, operation 700 continues for (C) from FIG. 7A. Regarding (B) continued from FIG. 7A, at block 738, a decision is made if the tim4 value of the interrupt is less than <5 min (Y/N). If Y, operation 700 proceeds to block 740, and, if N, operation 700 proceeds to block 764. At block 740, a decision is made if the tim4 value of the interrupt is less than <6 ms (Y/N). If Y, operation 700 proceeds to block 742, and, if N, operation 700 proceeds to block 754. At block 742, the battery (e.g., rechargeable battery 110) is stopped from charging and a function call is made to GPIO_WriteLow (GPIOC, BAT_ON):. At block 743, a decision is made if the time4 value of the interrup equals=4 ms (Y/N). If Y, operation 700 proceeds to block 744, and, if N, operation 700 proceeds to block 771. At block 744, the battery voltage is read and a call to the analog-to-digital (AD) conversion function is made and operation 700 proceeds to block 770. At block 754, a decision is made if the tim4 value of the interrupt is less than <21 ms (Y/N). If Y, operation 700 proceeds to block 756, and, if N, operation 700 proceeds to block 762 and can return to a previous operation such as block 704 or block 702. At block 756, the battery is stopped from charging and a function call is made to GPIO_WriteLow(GPIOC, BAT_ON):. At block 758, a decision is made if tim4 value of the interrupt is equal=11 ms (Y/N). If Y, operation 700 proceeds to block 760, and, if N, operation 700 proceeds to block 762 and can return to a previous operation. At block 760, the battery voltage is read and a call is made to an analog-to-digital (AD) conversion function and operation 700 proceeds to block 762.

At block 764 if the decision at block 738 is N, a decision is made if tim4<1000 ms (Y/N). If Y, operation 700 proceeds to block 766 and if N operation 700 proceeds to block 768. At block 766, the battery is stopped from charging and a function call is made to GPIO_WriteLow(GPIOC, BAT_ON). At block 768, a decision is made if tim4<30000 ms (Y/N). If Y, operation 700 proceeds to block 770 and if N operation 700 proceeds to block 771. At block 770, the battery is charged and a function call is made to GPIO_WriteHigh(GPIOC, BAT_ON). At block 771, operation 700 can return to a previous operation such as block 704 or block 702.

Regarding (C) continued from FIG. 7A, at block 746, a decision is made if the tim4 value of the interreupt is less than <100 ms. If Y, operation 700 proceeds to block 748, and, if N, operation 700 proceeds to block 750. At block 748, the battery is stopped from charging battery and a function call is made to GPIO_WriteLow(GPIOC, BAT_ON):. At block 750, a decision is made if the tim4 value of the interrupt is less than <30000 ms (Y/N). If Y, operation 700 proceeds to block 752, and, if N, operation 700 proceeds to block 771 and can return to a previous operation such as block 704 or block 702. At block 752, the battery is charged and a function call is made to GPIO_WriteHigh(GPIOC, BAT_ON): and operation 700 proceeds to block 771 and can return to a previous operation such as block 704 or block 702.

FIG. 7C is one example of a continuation of the flow diagram and operation 700 of FIG. 7A. At block 772, operation 700 continues for (A) from FIG. 7A. At block 774, a decision is made if the battery (e.g., rechargeable battery 110) is in float charge mode (Y/N). If Y, operation 700 proceeds to block 776, and, if N, operation 700 proceeds to block 788. At block 776, a decision is made if the tim4 value of the interrupt is less than <2 ms (Y/N). If Y, at block 778, the battery is charged (e.g., rechargeable battery 110) and a function call is made to GPIO_WriteHigh(GPIOC, BAT_ON): and operation 700 proceeds to block 780. If N, operation 700 proceeds to block 782. At block 780, a decision is made if the tim4 value of the interrupt is equal to=6 ms (Y/N). If Y, at block 782, the battery voltage is read and a function call is made to the analog-to-digital (AD) conversion function. If N, operation 700 proceeds to block 784. At block 784, a decision is made if the tim4 value of the interrupt is less than <100 ms (Y/N). If Y, at block 786, the battery is stopped from charging and a function call is made to GPIO_WriteLow(GPIOC, BAT_ON): and operation 700 proceeds to block 796 which can return to a previous operation such as block 704 or block 702. If N, operation 700 proceeds to block 796 and returns to a previous operation.

At block 788, if N for block 774, a decision is made if the battery needs to stop charging (Y/N). If Y, operation 700 proceeds to block 790, and, if N, operation 700 proceeds to block 796 and can return to a previous operation. At block 790, a decision is made if the tim4 value equals=30000 ms (Y/N). If Y, at block 792, the battery voltage is read and a function call is made to the analog-to-digital (AD) conversion function and operation 700 proceeds to block 794. If N, operation 700 proceeds to block 796 and can return to a previous operation. At block 794, the battery is stopped from charging and a function call is made to GPIO_WriteLow (GPIOC, BAT_ON): and operation 700 proceed: to block 796 that can return to a previous operation.

Thus, the disclosed embodiments and examples provide operations for an emergency (EM) driver including determining if a voltage for a rechargeable battery is below a first threshold; charging the rechargeable battery with a constant charge current if the voltage for rechargeable battery is determined to be below the first threshold; determining if the voltage for the rechargeable battery is not increasing; and floating the charge current for the rechargeable battery if the voltage for the rechargeable battery is determined not to be increasing.

For one example, an EM driver operation includes determining if the rechargeable battery is fully charged and the voltage on the rechargeable battery is below a second threshold; and maintaining the constant charge current to the rechargeable battery if the rechargeable battery is determined to be fully charged and the voltage on the rechargeable battery is determined to below the second threshold. The EM driver operation also includes stopping the constant charge current to the rechargeable battery if the rechargeable battery is determined to be fully charged and the voltage on the rechargeable battery is determined not to be below the second threshold. The first threshold can be 10.3V and the second threshold can be 10.65V. The rechargeable battery can be a LiFePO₄ rechargeable battery.

For one example, the constant charge current is approximately 15 mA and charging the rechargeable battery with the constant charge current includes sustaining a standby power loss of less than 0.5 W. The EM driver operation can further include providing the constant charge current from a charge circuit including a flyback circuit followed by a buck circuit and providing power to a multi-color indicator circuit and a micro-controller unit of about 100 mW. The EM driver operation can also include turning on at least two LED light indicators providing information regarding the mode of operation for the EM driver.

In the foregoing specification, specific examples and exemplary embodiments have been disclosed and described. It will be evident that various modifications may be made to those examples and embodiments without departing from the broader spirit and scope. The specification and drawings are, accordingly, to be regarded in an illustrative sense rather than a restrictive sense.

1. An emergency light emitting diode (LED) driver system comprising:
a LED light source;
a rechargeable battery coupled with the LED light source; and
an emergency (EM) driver coupled with the rechargeable battery and the LED light source, the EM driver including
a charge circuit configured to supply a charge current to the rechargeable battery, and
a micro-controller unit configured to control the charge current from the charge circuit such that a power loss in at least standby mode is less than 0.5 watts (W).

2. The emergency LED driver system of claim 1, wherein the rechargeable battery is a LiFePO₄ rechargeable battery.

3. The emergency LED driver system of claim 2, wherein the LiFePO₄ rechargeable battery is an emergency illumination light source.

4. The emergency LED driver system of claim 1, wherein the charge circuit includes a flyback circuit followed by a buck circuit, and wherein the micro-controller unit is configured to control charge current supplied by the charge circuit to the rechargeable battery.

5. The emergency LED driver system of claim 4, wherein the micro-controller unit is configured to control the charge current at a charge rate (C-rate) of at least 0.005 C for providing at least 9.6 volts (V) and 3000 mili-amps (mA) to the rechargeable battery.

6. The emergency LED driver system of claim 4, wherein the micro-controller unit is configured to provide a minimum switching frequency of 600 Hz to 1 kHZ.

7. The emergency LED driver system of claim 6, wherein the minimum switching frequency is user configurable.

8. The emergency LED driver system of claim 6, wherein the switching frequency is to maintain a standby power consumption of less than 200 mW.

9. The emergency LED driver system of claim 1, wherein the micro-controller unit is configured to provide a charge current of 15 mA to the rechargeable battery and maintain the rechargeable battery when fully charged to about 10.65 V.

10. The emergency LED driver system of claim 1, further comprising:
a multi-color indicator circuit configured to a provide at least two LED light indicators providing information regarding the mode of operation for the EM driver.

11. An emergency (EM) driver method comprising:
determining if a voltage for a rechargeable battery is below a first threshold;
charging the rechargeable battery with a constant charge current if the voltage for rechargeable battery is determined to be below the first threshold;
determining if the voltage for the rechargeable battery is not increasing; and
floating the charge current for the rechargeable battery if the voltage for the rechargeable battery is determined not to be increasing.

12. The EM driver method of claim 11, further comprising:
determining if the rechargeable battery is fully charged and the voltage on the rechargeable battery is below a second threshold; and
maintaining the constant charge current to the rechargeable battery if the rechargeable battery is determined to be fully charged and the voltage on the rechargeable battery is determined to below the second threshold.

13. The EM driver method of claim 12, further comprising stopping the constant charge current to the rechargeable battery if the rechargeable battery is determined to be fully charged and the voltage on the rechargeable battery is determined not to be below the second threshold.

14. The EM driver method of claim 13, wherein the first threshold is 10.3V and the second threshold is 10.65V.

15. The EM driver method of claim 11, wherein the rechargeable battery is a LiFePO₄ rechargeable battery.

16. The EM driver method of claim 11, wherein the constant charge current is approximately 15 mA.

17. The EM driver method of claim 11, wherein charging the rechargeable battery with the constant charge current includes sustaining a standby power loss of less than 0.5 W.

18. The EM driver method of claim 17, further comprising providing the constant charge current from a charge circuit including a flyback circuit followed by a buck circuit.

19. The EM driver method of claim 17, further comprising providing power to a multi-color indicator circuit and a micro-controller unit of about 100 mW.

20. The EM driver method of claim 19, further comprising turning on at least two LED light indicators providing information regarding the mode of operation for the EM driver.
